(19) United States
(12) Patent Application Publication
(10) Pub. No.: US 2016/0303472 A1
(43) Pub. Date: Oct. 20, 2016

(54) POLYGON PUZZLE AND RELATED METHODS

(71) Applicant: Rebecca KLEMM, Washington, DC (US)

(72) Inventor: Rebecca KLEMM, Washington, DC (US)

(21) Appl. No.: 15/192,923

(22) Filed: Jun. 24, 2016

Related U.S. Application Data
(63) Continuation-in-part of application No. 14/166,385, filed on Jan. 28, 2014, now Pat. No. 9,403,084.

(51) Int. Cl. A63F 9/10; G09B 23/04

(52) U.S. Cl. CPC A63F 9/10; G09B 23/04

(57) ABSTRACT

A puzzle, comprising at least one set of a plurality puzzle pieces, each of the puzzle pieces within the at least one set having a geometric shape with the same number of sides; and the set of pieces being adapted to fit together to form an equilateral or non-equilateral geometric shape having the same number of sides as each component puzzle piece, and a method of assembling a puzzle.

### RELATED APPLICATIONS

This application is a continuation-in-part of U.S. patent application Ser. No. 14/166,385, the benefit of the filing date of which is claimed herein and the entire contents and disclosure of which is incorporated herein by reference.

### TECHNICAL FIELD

This patent application relates generally to puzzles, and more specifically, to an educational puzzle and related methods.

### SUMMARY

One embodiment of the invention relates to a puzzle comprising at least one set of a plurality puzzle pieces, all of the puzzle pieces within the at least one set having a geometric shape with the same number of sides and adapted to fit together to form an equilateral or non-equilateral geometric shape having the same number of sides as each component puzzle piece. The geometric shape has at least five sides.

Another embodiment concerns a method of assembling a puzzle comprising: providing at least one set of a plurality puzzle pieces, all of the puzzle pieces within the at least one set having a geometric shape with the same number of sides and fitting them together to form an equilateral or non-equilateral geometric shape having the same number of sides as each component puzzle piece.

According to embodiments, some aspect of the present invention, the puzzle pieces can bear a mathematical correlation to the geometric shape which the puzzle piece form. The mathematical correlation is that the puzzle pieces have different shapes from each other and from the corresponding geometric shape to be formed. Also, the puzzle pieces have the same number of sides as the corresponding geometric shape to be formed.

### BRIEF DESCRIPTION OF THE DRAWINGS

The features and advantages of the invention will be apparent from the following description, as illustrated in the accompanying drawings wherein like reference numbers generally indicate identical, functionally similar, and/or structurally similar elements.

FIG. 1 is a perspective view of an embodiment of a puzzle according to the present invention.

FIG. 2 is a perspective view of a set of puzzles of varying geometric shapes.

### DETAILED DESCRIPTION

Embodiments of the invention are discussed in detail below. In describing embodiments, specific terminology is employed for the sake of clarity. However, the invention is not intended to be limited to the specific terminology so selected.

While specific embodiments are discussed, it should be understood that this is done for illustration purposes only. A person skilled in the relevant art will recognize that other components and configurations can be used without departing from the spirit and scope of the invention.

The invention described herein differs from that described in the parent application primarily in that whereas the latter requires a puzzle board, the former does not

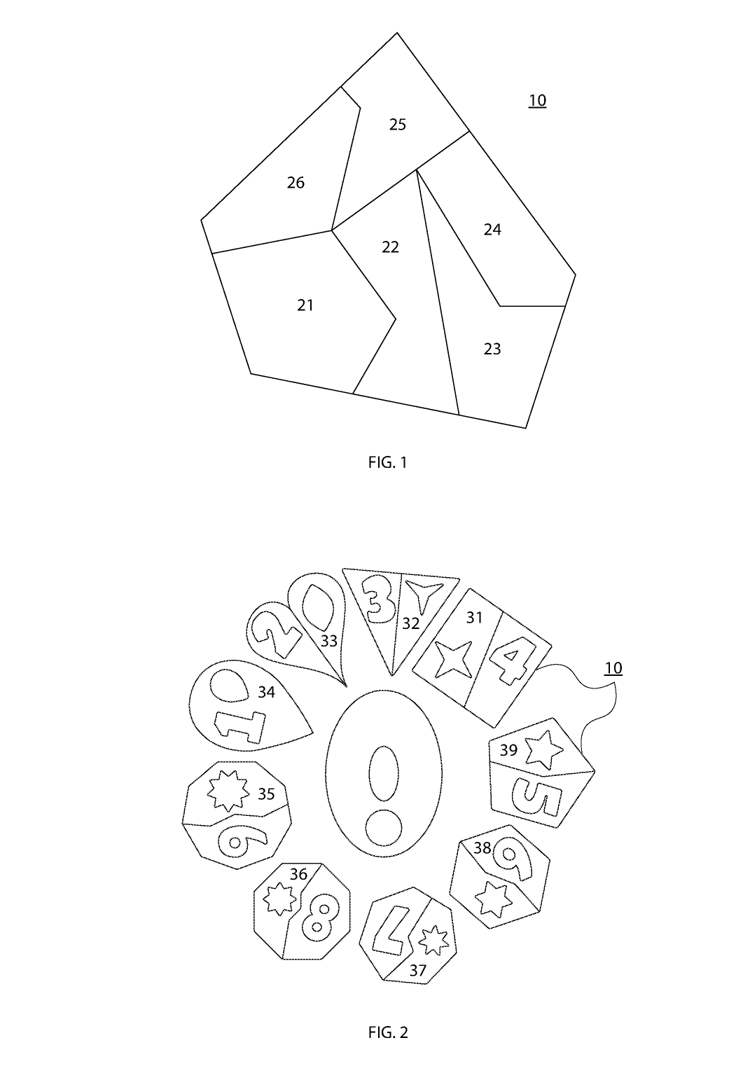

Referring to FIGS. 1-2, embodiments of puzzles 10 according to the present invention are shown. As shown in FIG. 1, the shape may be pentagonal and consist of pieces 21, 22, 23, 24, 25, 26 or it may assume any of the shapes depicted in FIG. 2. Each of the pieces 31, 32, 33, 34, 35, 36, 37, 38, 39 can have a different geometric shape, for example, with different amounts of “sides” or edges defining the geometric shape; e.g., hexagon, heptagon, octagon, nonagon, and decagon, among many others. Each of the puzzle pieces can have a different geometric shape from each other, for example, with different amounts of “sides” or edges defining the geometric shape. The number of sides or edges of the puzzle piece is equal to the number of sides of the geometric shape to be formed with the puzzle pieces. The number of sides of the shape should at least be five. When the puzzle pieces are manipulated and arranged together, they form the corresponding geometric shape with the same number of sides of each of the puzzle pieces that form the geometric shape.

One of ordinary skill in the art will understand based on this disclosure that the invention is not limited to any specific shape or configuration of puzzle, or number, shape, and appearance of puzzle pieces. The puzzle pieces are adapted such that they are not required to fit into a cutout. Rather, each puzzle piece can define an outer periphery that has the same, or substantially the same, shape as the outer periphery of the corresponding geometric shape. For example, as shown in FIG. 2, the geometric shape is a pentagon, 10. Puzzle pieces 21,22, 23, 24, 25 and 26, individually, do not mirror the specific shape of the pentagon, 10. Rather, the pieces 21,22, 23, 24, 25 and 26 have the same number of sides as the geometric shape, 10. The user, after recognizing puzzle pieces with the same number of sides as the geometric shape 10, can manipulate the pieces 21,22, 23, 24, 25 and 26 to form the geometric shape, as shown in FIG. 2. The pieces fit together or mate with one another. The puzzle pieces have a different shape from the geometric shape to the formed but have the same number of sides as the corresponding geometric shape. The invention provides that any equilateral polygon of n sides, where n is greater than or equal to five, can be deconstructed into k polygons of n sides, where k is greater than or equal to 1. N and K are integers.

The puzzle and its various parts can be constructed using any number of techniques in the art. For example, embodiments can be constructed from paper, cardboard, plastic, or wood. Alternatively, embodiments can be implemented in electronic form, such as an internet-based format, a smartphone app, or a computer program, where the various parts of the puzzle are depicted on the screen of a computer, tablet, smartphone, or other device. Accordingly, the invention should not be limited to embodiment in any specific form or media. The various mathematical relationships described above can be used to guide the players in assembling the puzzle. For example, the players can count the number of sides or points on each puzzle piece to determine which puzzle the piece fits into.

Other mathematical relationships may be used to correlate the puzzle pieces and the corresponding geometric shape. For example, and without limitation, the pieces may have an image of a bug, animal, number, object, or other item that includes the same number of certain parts (e.g., legs) as the sides of the geometric shape to be formed. One of ordinary skill in the art will appreciate based on this disclosure that a variety of different shapes or images can be used to correlate the puzzle pieces with the corresponding geometric shape.

The various mathematical relationships described above can be used to guide the players in assembling the puzzle or geometrical shape 10. For example, the players can count the number of sides or points on each puzzle piece to determine which geometric shape is to be formed. The shape alone of the geometric shape and puzzle pieces can also be used to guide the player in assembling the puzzle 10.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A puzzle, comprising:
at least one set of a plurality puzzle pieces, each of the puzzle pieces within the at least one set having a geometric shape with the same number of sides; and
said set of pieces being adapted to fit together to form a geometric shape having the same number of sides as each component puzzle piece, wherein the plurality of puzzle pieces have at least five sides.

2. The puzzle of claim 1, wherein the geometric shape is selected from the group comprising pentagon, hexagon, heptagon, octagon, nonagon, decagon or a polygon with at least five sides.

3. The puzzle of claim 1, wherein the puzzle pieces feature puzzle piece shapes, wherein the puzzle piece shape is not identical to the geometric shape.

4. The puzzle of claim 1, wherein the geometric shape is an equilateral geometric shape.

5. The puzzle of claim 1, wherein the geometric shape is a non-equilateral geometric shape.

6. A method of assembling a puzzle comprising:
providing at least one set of a plurality puzzle pieces, each of the puzzle pieces within the at least one set having a geometric shape with the same number of sides, and
fitting the plurality of puzzle pieces together to form a geometric shape having the same number of sides as each component puzzle piece, wherein the plurality of puzzle pieces have at least five sides.

7. The method of claim 6, wherein the geometric shape is selected from the group comprising pentagon, hexagon, heptagon, octagon, nonagon, decagon or a polygon with at least five sides.

8. The method of claim 6, wherein the puzzle pieces feature puzzle piece shapes, wherein the puzzle piece shape is not identical to the geometric shape.

9. The method of claim 6, wherein the geometric shape is an equilateral geometric shape.

10. The method of claim 6, wherein the geometric shape is a non-equilateral geometric shape.
